(19) United States
(12) Patent Application Publication
(10) Pub. No.: US 2025/0269575 A1
(43) Pub. Date: Aug. 28, 2025

(54) MOLDING MANAGEMENT SYSTEM

(71) Applicant: SEIKO EPSON CORPORATION, Tokyo (JP)

(72) Inventors: Kosuke ATSUTA, SHIOJIRI-SHI (JP); Yusuke MITSUMA, SHIOJIRI-SHI (JP); Soji SHIOZAWA, MATSUMOTO-SHI (JP)

(21) Appl. No.: 19/064,188

(22) Filed: Feb. 26, 2025

(30) Foreign Application Priority Data
Feb. 28, 2024 (JP) 2024-028159

(51) Int. Cl. B29C 45/76

(52) U.S. Cl. CPC B29C 45/768; B29C 2045/7606; B29C 2945/76103; B29C 2945/7629

(57) ABSTRACT

A molding management system that manages production of a product in a production process including an injection molding process of the product by an injection molding device, the molding management system includes a server communicably connected to a terminal device, wherein the server includes a storage section configured to store one or more sets of lot information in which lot identification information for identifying a lot of the product and lot related information including one or more sets of information relating to the lot of the product are associated with each other and a control section configured to cause the terminal device to display a nonconforming product information addition image for receiving a nonconforming product information addition operation for adding, to the lot information that indicates a target lot that was selected from the lots indicated by each of one or more sets of the lot information stored in the storage section, nonconforming product information including nonconforming product quantity information indicating the number of nonconforming products.

The present application is based on, and claims priority from JP Application Serial Number 2024-028159, filed Feb. 28, 2024, the disclosure of which is hereby incorporated by reference herein in its entirety.

### BACKGROUND

### 1. Technical Field

This disclosure relates to a molding management system.

### 2. Related Art

Research and development have been conducted on a technique for managing the production of a product in a production process including an injection molding stage of the product by an injection molding device using a material such as plastic.

In this regard, a system is known in which control information for controlling the molding of the product for each lot can be updated for each molding of the product (see JP-B-7-029352).

In the system such as that described in JP-B-7-029352, when a nonconforming product is generated at the molding site of a product, division of a lot or the like for separating the conforming product and the nonconforming product may be performed, and as a result, a difference may occur between the actual lot and the lot in the system. This is because lots are managed by master data in the system. However, it is not desirable from the viewpoint of lot management.

### SUMMARY

To solve the above described problem, an aspect of the present disclosure provides a molding management system that manages production of a product in a production process including an injection molding process of the product by an injection molding device, the molding management system includes a server communicably connected to a terminal device, wherein the server includes a storage section configured to store one or more sets of lot information in which lot identification information for identifying a lot of the product and lot related information including one or more sets of information relating to the lot of the product are associated with each other and a control section configured to cause the terminal device to display a nonconforming product information addition image for receiving a nonconforming product information addition operation for adding, to the lot information that indicates a target lot that was selected from the lots indicated by each of one or more sets of the lot information stored in the storage section, nonconforming product information including nonconforming product quantity information indicating the number of nonconforming products.

### BRIEF DESCRIPTION OF THE DRAWINGS

FIG. 1 is a diagram showing an example of a configuration of a molding management system 1.

FIG. 2 is a diagram showing an example of a main menu image P1.

FIG. 3 is a diagram showing an example of a terminal image P2.

FIG. 4 is a diagram showing an example of a nonconforming product information addition image P3.

FIG. 5 is a view showing an example of a nonconforming product information display image P5 displayed by a selection operation at a button B31 shown in FIG. 4.

FIG. 6 is a diagram showing an example of a nonconforming product information input image P6.

FIG. 7 is a diagram showing an example of a state in which a pull-down menu of an input field F42 is displayed.

FIG. 8 is a diagram showing an example of a state in which a nonconforming reason information is input to the input field F42.

FIG. 9 is a diagram showing an example of a state in which nonconforming product information is displayed in a nonconforming product information display region RG1 as a result of a selection operation at a button B51 shown in FIG. 8.

FIG. 10 is a diagram showing the nonconforming product information display image P5 indicated in FIG. 9.

FIG. 11 is a diagram showing an example of the nonconforming product information input image P6 on which a message MS indicating that the addition of the nonconforming product information to a lot information indicating a target lot is completed is displayed.

FIG. 12 is a diagram showing an example of a table indicating the number of products of each of certain five lots.

FIG. 13 is a diagram showing another example of the number of products in each of certain five lots.

FIG. 14 is a diagram showing still another example of the number of products in each of certain five lots.

FIG. 15 is a diagram showing an example of a correspondence relationship reception image P7.

FIG. 16 is a diagram for explaining another example of an input method of a shot identification information to the right adjacent field of the lot identification information in a correspondence table TB1 shown in FIG. 15.

FIG. 17 is a table showing an example of a case where a list of the lot information is displayed using the shot identification information as a primary key.

FIG. 18 is a diagram showing an example of a hardware configuration of a server 30.

FIG. 19 is a diagram showing an example of a functional configuration of the server 30.

FIG. 20 is a diagram showing an example of a flow of process in which the server 30 adds a nonconforming product information to the lot information.

### DESCRIPTION OF EMBODIMENTS

### Embodiment

Hereinafter, embodiments of the present disclosure will be described with reference to the drawings.

### Overview of Molding Management System

First, an outline of the molding management system according to the embodiment will be described.

A molding management system according to the embodiment manages the production of a product in a production process including an injection molding process of the product by an injection molding device. The molding management system includes a server. The server is communicatively connected to a terminal device. The server includes a storage section and a control section. The storage section is configured to store one or more sets of lot information in which lot identification information for identifying a lot of the product and lot related information including one or more sets of information relating to a lot of the product are associated with each other. The control section causes the terminal device to display a nonconforming product information addition image for receiving a nonconforming product information addition operation for adding, to a nonconforming product information including a nonconforming product quantity information indicating the number of nonconforming products to the lot information indicating a target lot selected from the lots indicated by each of one or more sets of the lot information stored in the storage section.

By this, the molding management system according to the embodiment can suppress the occurrence of a difference between the actual lot in which the nonconforming product is generated and the lot on the molding management system.

Hereinafter, each of the configurations of the molding management system according to the embodiment and the process performed by the server included in the molding management system will be described in detail.

Note that the addition of nonconforming product information to the lot information is necessary, for example, when the nonconforming product occurs in the molding process of the product of the lot, or the nonconforming product occurs in an assembly process for the product or in a subsequent process such as the sampling inspection process. For example, the nonconforming product information added to the lot information indicating a certain lot makes it possible to set a condition that the number of conforming products becomes a predetermined number as a condition for the completion of a box for packing the products of the lot, instead of setting a condition that the number of products becomes a predetermined number. For example, when the nonconforming product information added to the lot information indicating a certain lot excludes the nonconforming product from the box for packing the product of the lot, it also can be used to determine whether or not to pack the same number of conforming products as the number of excluded nonconforming products in the box. In this way, the addition of nonconforming product information to the lot information is useful because it leads to more detailed control of the lot.

### Configuration of the Molding Management System

Hereinafter, the configuration of the molding management system according to the embodiment will be described using a molding management system 1 as an example.

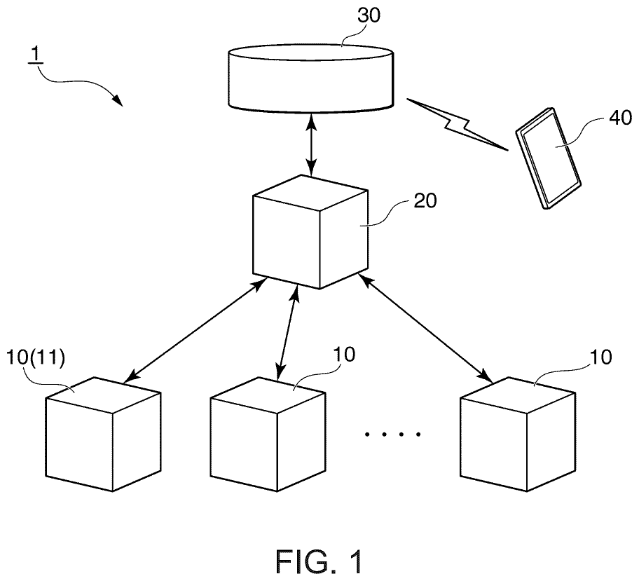

FIG. 1 is a diagram showing an example of a configuration of the molding management system 1.

The molding management system 1 is a kind of manufacturing execution system (MES). For example, the molding management system 1 includes one or more of managed devices 10, an information process device 20, and a server 30. Note that the molding management system 1 may be configured not to include part or all of one or more of the managed devices 10. The molding management system 1 may have a configuration that does not include the information process device 20. Hereinafter, as an example, a case will be described in which the molding management system 1 includes a plurality of managed devices 10 as one or more of the managed devices 10.

Each of the plurality of managed devices 10 included in the molding management system 1 is a device managed by the molding management system 1. In FIG. 1, each of the plurality of managed devices 10 is indicated by the same reference symbol for convenience of explanation. However, some or all of the plurality of managed devices 10 may be different types of managed devices. The plurality of managed devices 10 includes at least one injection molding device that performs injection molding of the product using a resin such as plastic. An injection molding device 11 shown in FIG. 1 is an example of such an injection molding device. Note that the plurality of managed devices 10 may include an injection molding device that performs metal powder injection molding (MIM: Metal Injection Molding) of the product. Hereinafter, for convenience of description, the injection molding of a product using a resin such as plastic will be simply referred to as injection molding. In the following description, an injection molding device that performs injection molding of a product using a resin such as plastic is simply referred to as an injection molding device. The plurality of managed devices 10 includes, for example, a peripheral equipment of the injection molding device in addition to the injection molding device. The peripheral equipment of the injection molding device includes, but is not limited to, for example, a material supply device for supplying the injection molding device with material used in injection molding of the product by the injection molding device, a transport device for transporting the product of injection molding by the injection molding device, a cleaning device for cleaning the product of injection molding by the injection molding device, a sintering device for sintering the product after being cleaned by the cleaning device, and the like. At least one injection molding device included in the plurality of managed devices 10 may be a device for performing injection molding using a material other than resin and metal.

The molding management system 1 manages the production of a product in the production process, which includes the injection molding process of the product by the injection molding device included in the plurality of managed devices 10. Here, the injection molding device included in the plurality of managed devices 10 may have any configuration as long as it is capable of producing the product by injection molding. Hereinafter, for convenience of description, one injection molding of the product by the injection molding device will be referred to as one shot and described. In this case, for example, two shots means injection molding of the product twice by the injection molding device. Hereinafter, for convenience of description, each of one or more of the cavities in a metal mold filled with a resin in the molding of the product in one shot will be described as a cavity. For example, the injection molding device fitted with a metal mold having two such cavities will mold two products in one shot.

The information process device 20 acquires state information indicating the state of each of the plurality of managed devices 10 from the managed device 10. For example, the information process device 20 acquires the state information of the injection molding device 11 from the injection molding device 11. Such state information includes a time stamp indicating the date and time when the state information was acquired by the information process device 20. Certain state information includes device identification information for identifying the managed device 10 in the state indicated by the state information. The state information includes detection information detected by one or more of the various sensors attached to the managed device 10. The detection information includes, for example, information indicating temperature, information indicating pressure, information indicating current value, and information indicating voltage value. That is, one or more of the various sensors are, for example, a thermometer, a pressure gauge, an ammeter, a voltmeter, and the like, but are not limited to these. Note that the detection information may include configurations where other information detected by the sensor is included instead of a part or all of the above information or in addition to all of the above information. The state information includes operating state information indicating the operating state of the managed device 10. The operating state information indicating the operating state of the managed device 10 may be any state information as long as it includes information indicating whether or not the managed device 10 is operating. The acquisition of state information by the information process device 20 may be performed periodically or non-periodically. Hereinafter, as an example, a case will be described in which the state information is acquired by the information process device 20 every time the one shot described above is performed. When the information process device 20 acquires certain state information, it outputs the acquired state information to the server 30. By this, the information process device 20 can store the acquired state information in the server 30.

The information process device 20 is, for example, a workstation, a desktop Personal Computer (PC), a notebook PC, or the like, but is not limited to these. The information process device 20 is communicably connected to each of the plurality of managed devices 10 via wired or wireless communication. A communication network for connecting the information process device 20 and each of the managed devices 10 is, for example, a Local Area Network (LAN) in a facility where the plurality of managed devices 10 is installed, but is not limited to this. The communication network may be another communication network such as the Internet or a mobile communication network.

The server 30 stores the state information acquired by the information process device 20. For example, when the server 30 acquires certain state information from the information process device 20, the server 30 stores the acquired state information. Here, when the server 30 has already stored the state information including the device identification information included in the state information, the server 30 replaces the already stored state information with the newly acquired state information. By this, the server 30 can always keep the state information indicating the state of the managed device 10 indicated by the device identification information to be the latest state information. Note that the server 30 may be configured to store all the acquired state information without performing such a replacement. The server 30 may be configured so that, even when such a replacement is performed, it newly stores the state information before the replacement as the history information indicating the history of the state of the managed device 10.

In response to a request from the terminal device communicably connected to the server 30, the server 30 causes a display section of the terminal device to display various images based on the state information stored in the server 30. Here, the image is a Graphical User Interface (GUI), an icon, a window on an operating system (OS), or the like. Hereinafter, as an example, a case will be described in which the server 30 is communicably connected to a terminal device 40 as shown in FIG. 1. Note that in the present embodiment, the process relating to the login to the server 30 by the terminal device 40 is a known process, and therefore, the description thereof will be omitted. Hereinafter, for convenience of description, the server 30 receiving an operation from the terminal device 40 via the image displayed on the terminal device 40 will be simply referred to as the server 30 receiving an operation and described. That is, in the following description, the server 30 performs a certain process in response to the received operation means that the server 30 performs the process in response to the operation received from the terminal device 40 via the image displayed on the terminal device 40.

The server 30 accepts various kinds of information according to the received operation. For example, the server 30 stores master data including various kinds of information for the product produced by the injection molding device 11 according to the received operation. The master data includes, for example, product identification information for identifying various products produced by the injection molding device 11, product type information indicating the type of the product identified by each product identification information, production quantity planned value information indicating the planned value of the production quantity of the product identified by each product identification information, metal mold identification information for identifying the metal mold used to produce the product identified by each product identification information, and the like. The data structure of the master data may be any structure. For example, various kinds of information included in the master data are included in the master data as information associated with the product identification information. Note that various kinds of information included in the master data may be associated with the product type information instead of the product identification information, may be associated with both the product identification information and the product type information, or may be associated with other identification information.

In response to the received operation, the server 30 causes the display section of the terminal device 40 to display a lot search image for receiving a lot search operation for searching a lot of the product. The display section is, for example, the display of the terminal device 40, a display device communicably connected to the terminal device 40, or the like, but is not limited to this. Hereinafter, as an example, a case will be described in which the display section is the display of the terminal device 40. Hereinafter, for convenience of description, the action of displaying a certain image on the display section will be referred to as displaying the image. The lot search image is an image for receiving various kinds of information that can be used as a search key by the aforementioned lot search operation. Note that hereinafter, for convenience of description, a lot of a product will be simply referred to as a lot. The lot is a group of one or more of the products to which lot identification information is assigned for management reasons. Therefore, hereinafter, for convenience of description, a product to which lot identification information identifying a certain lot is assigned will be referred to as a product of that lot. The lot identification information may be any identification information as long as it can identify the identification of the lot, for example, an ID (Identifier) that identifies the lot, a character string that identifies the lot, or any other identification information capable of identifying the lot.

Here, the server 30 stores the lot identification information and the lot related information, which includes one or more sets of information relating to the lot, in association with each other. By this, when the server 30 searches for information of the product of a certain lot, one or more sets of information included in the lot related information associated with the lot identification information can each be used as the search key for searching for the lot together with the lot identification information for identifying the lot. In other words, in the lot search image, in addition to the lot identification information, one or more sets of information included in the lot related information can each be used as the search key to search for the lot. Hereinafter, for convenience of description, information in which lot identification information for identifying a certain lot and lot related information including one or more sets of information on the lot are associated with each other will be referred to as lot information indicating the lot. That is, when the server 30 receives at least one set of information among one or more sets of information included in the lot related information via the lot search image by the lot search operation, then the server 30 causes displays of the lot information indicating the lot identified by the one or more sets of the lot identification information associated with the received at least one set of information. By this, the server 30 can allow the user to easily search for information on the product of the lot desired by the user. Therefore, the server 30 stores the one or more sets of the lot information for each lot identification information. Here, the lot information is, for example, information that is generated or updated by information received from the user via one of the update functions executable by the server 30, and is information that is stored in the server 30. Certain lot information includes, for example, the lot identification information for identifying the lot indicated by the lot information and the lot related information related the lot. More specifically, the lot related information includes production quantity information indicating the number of products in the lot, product type information indicating the type of product in the lot, process information indicating a work process currently performed on the products of the lot, lot state information indicating the state of the lot, start date and time information indicating the date and time when the production of the products of the lot was started, quality information indicating the result of a quality inspection performed on the products of the lot, injection molding device related information relating to the injection molding device for molding the products of the lot, metal mold identification information for identifying the metal mold attached to the injection molding device, cavity quantity information indicating the number of cavities in the metal mold, and the like. The quality information is information indicating that a quality inspection has not been performed on the product when the quality inspection has not been performed on the product. The injection molding device related information includes, for example, injection molding device identification information for identifying the injection molding device, the operating state information indicating the operating state of the injection molding device, the detection information on the injection molding device, and the like. Note that the lot related information may include configurations where other information related to the lot is included instead of a part or all of the above information or in addition to all of the above information.

In response to the received operation, the server 30 causes display of a nonconforming product information addition image for receiving a nonconforming product information addition operation of adding nonconforming product information including nonconforming product quantity information indicating the number of the nonconforming products to the lot information indicating the selected target lot among the one or more sets of the lot information stored in the server 30. Here, the nonconforming product in the present embodiment is a Japanese Industrial Standards (JIS) nonconforming product. The nonconforming product may be referred to as a failure product, a Not Good (NG) product, or the like. The conforming product in the present embodiment refers is a JIS conforming product. The conforming product may also be referred to as a quality product, an OK product, or the like.

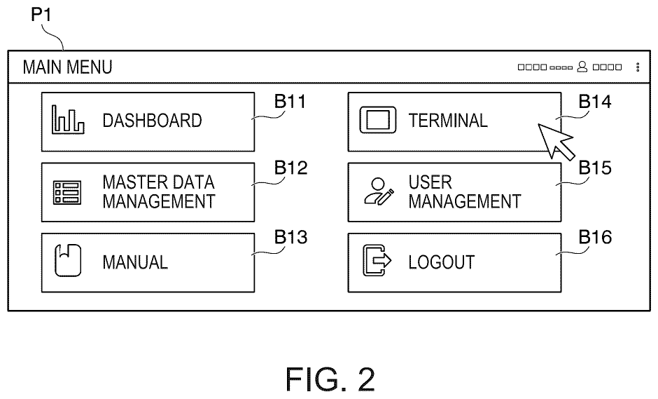

For example, the server 30 causes display of a nonconforming product information addition image by receiving an operation via a main menu image P1 as shown in FIG. 2. FIG. 2 is a diagram showing an example of the main menu image P1.

When receiving a predetermined main menu image display operation, the server 30 causes display of the main menu image P1. In the example shown in FIG. 2, the main menu image P1 includes six buttons of button B11 to button B16.

The button B11 is a button that displays a dashboard image. When a selection operation at the button B11 is received, the server 30 generates the dashboard image and causes display of the generated dashboard image. Here, the dashboard image is an image on which is displayed information necessary for the user to manage the production of the product by the injection molding device during the operation of the injection molding device designated by the user of the terminal device 40. In the present embodiment, the selection operation is a click, a tap, or similar actions, but is not limited to these.

The button B12 is a button that displays a master data management image. When a selection operation at the button B12 is received, the server 30 generates the master data management image and causes display of the generated master data management image. Here, the master data management image is an image for receiving the operation of inputting, changing, deleting, or the like of the master data described above. The server 30 can perform the generation, modification, deletion, and the like of master data in response to operations on the master data management image. When the server 30 generates the master data, the server 30 stores the generated master data. When the master data is changed, the server 30 updates the stored master data to the changed master data.

The button B13 is a button that displays a manual image. When a selection operation at the button B13 is received, the server 30 generates the manual image and causes display of the generated manual image. Here, the manual image is an image for receiving the operation for displaying the manual on an operation method of the molding management system 1.

The button B14 is a button that displays a terminal image P2. When a selection operation at the button B14 is received, the server 30 generates the terminal image P2 and causes display of the generated terminal image P2. Here, the terminal image P2 is an image for receiving the operation for executing each of the various update functions included in the server 30. Certain type of update function is a function of inputting, changing, deleting, and the like of information corresponding to the type.

The button B15 is a button that displays a user management image. When a selection operation at the button B15 is received, the server 30 generates the user management image and causes display of the generated user management image. Here, the user management image is an image for receiving the operation of performing inputting, changing, deleting, displaying, or the like of information relating to the user among the information stored in the server 30.

The button B16 is a button that receives an operation of logs out the terminal device 40 from the server 30. When a selection operation at the button B16 is received, the server 30 logs out the terminal device 40.

Note that in the present embodiment, the description of each of the dashboard image, the master data management image, the manual image, and the user management image will be omitted.

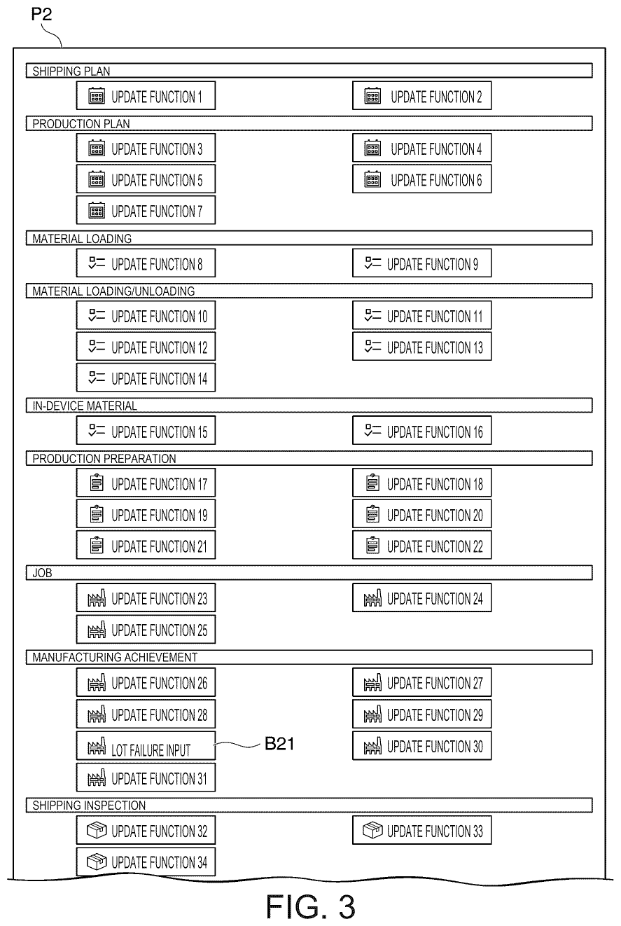

FIG. 3 is a diagram showing an example of the terminal image P2. As shown in FIG. 3, the terminal image P2 includes a button for receiving the operation for executing each of the plurality of update functions. One button among such buttons is a button B21.

The button B21 is a button that receives an operation to display a nonconforming product information addition image P3, which is an example of the nonconforming product information addition image. When a selection operation at the button B21 received, the server 30 generates the nonconforming product information addition image P3 and displays the generated nonconforming product information addition image P3.

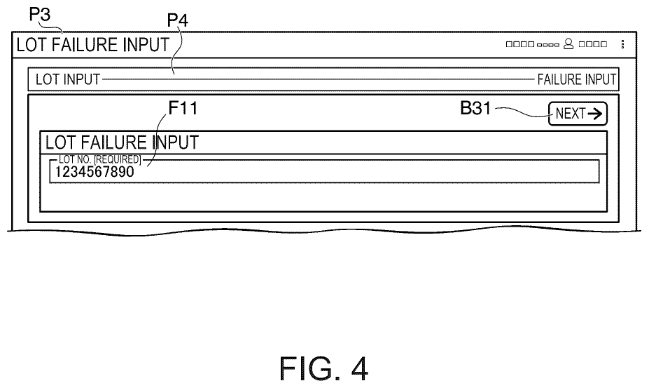

FIG. 4 is a diagram showing an example of the nonconforming product information addition image P3. In the example shown in FIG. 4, the nonconforming product information addition image P3 displayed by a selection operation at the button B21 includes a target lot designation image P4 for receiving an operation for designating the desired lot as the target lot to be subjected to the nonconforming product information addition operation. Note that the nonconforming product information addition image P3 may be configured to include another GUI.

In the example shown in FIG. 4, the target lot designation image P4 includes, for example, an input field F11 and a button B31. Note that the target lot designation image P4 may be configured to include another GUI instead of one or both of them, or in addition to both of these. Hereinafter, as an example, a case will be described in which the target lot designation image P4 is one of the images included in the nonconforming product information addition image P3. In this case, the function, the GUI, or the like of the target lot designation image P4 is also the function, the GUI, or the like of the nonconforming product information addition image P3.

The input field F11 is a field in which is input the lot identification information that identifies the lot designated by the user as the target lot. In FIG. 4, “LOT NO.”, which is a character string superimposed on the input field F11, is a character string for indicating to the use that the information to be input to the input field F11 is the lot identification information. In the example shown in FIG. 4, “1234567890” is input to the input field F11 as the lot identification information. Note that, the input of the lot identification information to the input field F11 may be performed by selecting the lot identification information from a pull-down menu or may be performed by direct input using an input device such as a keyboard.

The button B31 is a button that receives an operation of confirming the lot identification information input to the input field F11 as the lot identification information for identifying the target lot and displaying nonconforming product information display image P5 for displaying a list of the nonconforming product information included in the lot information indicating the target lot. When a selection operation at the button B31 is performed, the server 30 determines the lot identification information input to the input field F11 as the lot identification information that identifies the target lot. Then, the server 30 deletes the display of the target lot designation image P4 on the nonconforming product information addition image P3 and causes display of the nonconforming product information display image P5 on the nonconforming product information addition image P3. Here, in a case where a predetermined first gray-out condition is satisfied, the server 30 grays out the button B31 and does not accept a selection operation at the button B31. On the other hand, when the first gray-out condition is not satisfied, the server 30 cancels the gray-out of the button B31 and accepts the selection operation at the button B31. By such gray-out, the server 30 can suppress erroneous operations by the user. The first gray-out condition is, for example, a condition including a condition 1A below.

The condition 1A: The lot identification information is not input to the input field F11.

When the condition 1A is satisfied, the server 30 determines that the first gray-out condition is satisfied. On the other hand, when the condition 1A is not satisfied, the server 30 determines that the first gray-out condition is not satisfied.

In the example shown in FIG. 4, as described above, the lot identification information is input to the input field F11. Therefore, in the present example, the button B31 is not grayed out.

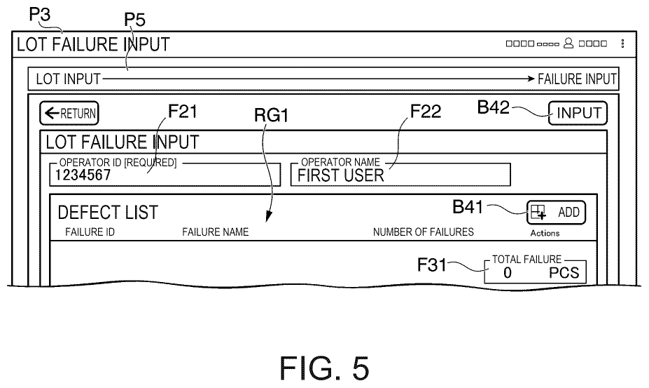

FIG. 5 is a view showing an example of the nonconforming product information display image P5 displayed by a selection operation at the button B31 shown in FIG. 4. Note that the server 30 may be configured to cause display of the nonconforming product information display image P5 in a pop-up manner, may be configured to cause display of the nonconforming product information display image P5 within the nonconforming product information addition image P3, may be configured to cause display of the nonconforming product information display image P5 in a separate window, or may be configured to cause display of the nonconforming product information display image P5 by other methods. However, hereinafter, as an example, a case will be described in which the nonconforming product information display image P5 is one of the images included in the nonconforming product information addition image P3, even if the nonconforming product information display image P5 is displayed by any of these methods. In this case, the functions, the GUI, or the like of the nonconforming product information display image P5 is also the function, the GUI, or the like of the nonconforming product information addition image P3.

The nonconforming product information display image P5 includes a GUI in which information about a user who adds nonconforming product information to the lot information indicating the target lot is input. In the example shown in FIG. 5, the nonconforming product information display image P5 includes an input field F21 and an input field F22 as the GUI. In the present example, the nonconforming product information display image P5 includes a nonconforming product information display region RG1, a button B41, a display field F31, and a button B42, in addition to the GUI. Note that the nonconforming product information display image P5 may be configured to include another GUI instead of some or all of these, or in addition to all of these.

The input field F21 is a field in which is input user identification information that identifies a user who adds the nonconforming product information to the lot information indicating the target lot. In FIG. 5, “OPERATOR ID”, which is a character string superimposed on the input field F21, is a character string for indicating to the user that the information to be input to the input field F21 is the user identification information. By default, for example, the user identification information of a user who is logging in to the server 30 is input to the input field F21. The method of determining the user identification information by the server 30 may be a known method or a method to be developed. In the example shown in FIG. 5, “1234567” is input to the input field F21 as the user identification information to be input by default. Note that the input of user identification information to the input field F21 other than the input of the default user identification information may be performed by selecting the user identification information from a pull-down menu or may be performed by direct input using the input device such as the keyboard.

The input field F22 is a field in which is input user name information that indicates the name of a user who adds the nonconforming product information. In FIG. 5, “OPERATOR NAME”, which is a character string superimposed on the input field F22, is a character string for indicating to the user that the information to be input to the input field F22 is the user name information. By default, for example, the user name information of a user who is logging in to the server 30 is input to the input field F22. The method of determining the user name information by the server 30 may be a known method or a method to be developed. In the example shown in FIG. 5, “FIRST USER” is input into the input field F22 as the user name information to be input by default. Note that the input of the user name information to the input field F22 other than the input of the default user name information may be performed by selecting the user name information from a pull-down menu or may be performed by direct input using the input device such as the keyboard.

The nonconforming product information display region RG1 is a region where the list is displayed of the nonconforming product information included in the lot information indicating the target lot. In the example shown in FIG. 5, nothing is displayed in the nonconforming product information display region RG1. This is because, in the present example, the lot information does not include the nonconforming product information.

The button B41 is a button that receives an operation to display the nonconforming product information input image P6. The nonconforming product information input image P6 is an image that accepts an operation of inputting the nonconforming product information to be added to the lot information indicating the target lot. When a selection operation at the button B41 is performed, for example, the server 30 causes display of the nonconforming product information input image P6 on the nonconforming product information display image P5.

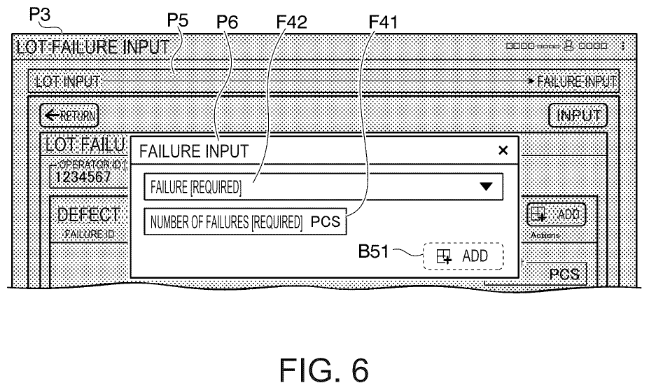

FIG. 6 is a diagram showing an example of the nonconforming product information input image P6. Note that the server 30 may be configured to cause display of the nonconforming product information input image P6 in a pop-up, may be configured to cause display of the nonconforming product information input image P6 within the nonconforming product information display image P5, may be configured to cause display of the nonconforming product information input image P6 within the nonconforming product information addition image P3, may be configured to cause display of the nonconforming product information input image P6 in a separate window, or may be configured to display the nonconforming product information input image P6 by another method. However, hereinafter, as an example, a case will be described in which the nonconforming product information input image P6 is one of the images included in the nonconforming product information addition image P3, even if the nonconforming product information input image P6 is displayed by any of these methods. In this case, the function, the GUI, or the like of the nonconforming product information input image P6 is also the function, the GUI, or the like of the nonconforming product information addition image P3.

In the example shown in FIG. 6, the nonconforming product information input image P6 is displayed as a pop-up on the nonconforming product information display image P5. In the present example, the nonconforming product information input image P6 includes an input field F41, an input field F42, and a button B51. Note that the nonconforming product information input image P6 may be configured to include another GUI instead of some or all of these, or in addition to all of these.

The input field F41 is a field in which is input the nonconforming product quantity information that indicates the number of nonconforming products designated by the user. In FIG. 6, “NUMBER OF FAILURES”, which is a character string superimposed on the input field F41, is a character string for indicating to the user that the information to be input to the input field F41 is the nonconforming product quantity information. In the example shown in FIG. 6, nothing is input to the input field F41. Note that the nonconforming product quantity information to the input field F41 may be performed by selecting the nonconforming product quantity information from a pull-down menu or may be performed by direct input using the nonconforming product quantity information through the input device such as the keyboard. The input field F41 is an example of a nonconforming product quantity information input image.

The input field F42 is a field in which is input nonconforming reason information that indicates the reason why the products, in the number indicated by the nonconforming product quantity information input to the input field F41, are nonconforming products. In FIG. 6, “FAILURE”, which is a character string superimposed on the input field F42, is a character string for indicating to the user that the information to be input to the input field F42 is nonconforming reason information. In the example shown in FIG. 6, nothing is input to the input field F42. Note that the input of the nonconforming reason information to the input field F42 may be performed by selecting the nonconforming reason information from a pull-down menu or may be performed by direct input using the input device such as the keyboard. The input field F42 is an example of a nonconforming reason input image. Hereinafter, as an example, a case will be described in which the input of the nonconforming reason information to the input field F42 is performed by selecting the nonconforming reason information from a pull-down menu. For example, when a selection operation to the “▾” mark included in the input field F42 is performed, the server 30 displays a pull-down menu in which a list of the one or more sets of the nonconforming reason information included in the master data is displayed. Note that the registration of the one or more sets of nonconforming reason information to the master data may be performed by any method. Therefore, a description of a method of registering the one or more sets of the nonconforming reason information to the master data will be omitted.

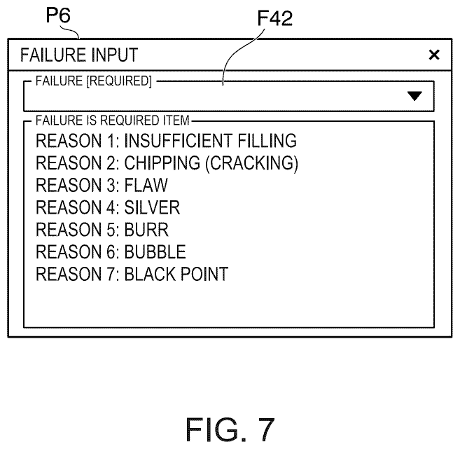

FIG. 7 is a diagram showing an example of a state in which a pull-down menu of the input field F42 is displayed. In the example shown in FIG. 7, a list of seven sets of the nonconforming reason information is displayed in the pull-down menu. Specifically, in the present example, these seven sets of nonconforming reason information are “REASON 1: INSUFFICIENT FILLING”, “REASON 2: CHIPPING (CRACKING)”, “REASON 3: FLAW”, “REASON 4: SILVER”, “REASON 5: BURR”, “REASON 6: BUBBLE”, and “REASON 7: BLACK POINT”. The user can select the desired nonconforming reason information from these seven sets of nonconforming reason information. When the server 30 receives an operation of selecting the desired nonconforming reason information from these seven sets of nonconforming reason information, the server 30 deletes the display of the pull-down menu and inputs the nonconforming reason information selected by the received operation to the input field F42.

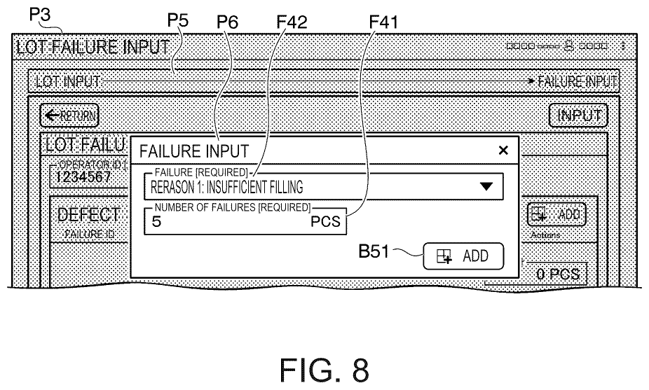

FIG. 8 is a diagram showing an example of a state in which the nonconforming reason information is input to the input field F42. In the example shown in FIG. 8, “REASON 1: INSUFFICIENT FILLING” is input as the nonconforming product information to the input field F42. In the present example, “5” is input to the input field F41 as the nonconforming product quantity information indicating that the number of nonconforming products is five.

The button B51 is a button that receives an operation to confirm the input of the information in the nonconforming product information input image P6. When a selection operation is performed at the button B51, the server 30 generates the nonconforming product information including the nonconforming product quantity information input to the input field F41, the nonconforming reason information input to the input field F42, and nonconforming product identification information newly generated as information for identifying the nonconforming product information. Then, the server 30 adds the generated nonconforming product information to the lot information indicating the target lot. Specifically, the server 30 adds the nonconforming product information to the lot information by associating the nonconforming product information with the lot identification information included in the lot information. Note that the server 30 may be configured to add the nonconforming product information to the lot information by associating the nonconforming product information with information other than the lot identification information included in the lot information. After adding the nonconforming product information to the lot information, the server 30 causes display of the nonconforming product information added to the lot information in the nonconforming product information display region RG1. However, even in this case, the server 30 retains the display of the nonconforming product information input image P6 without deleting it.

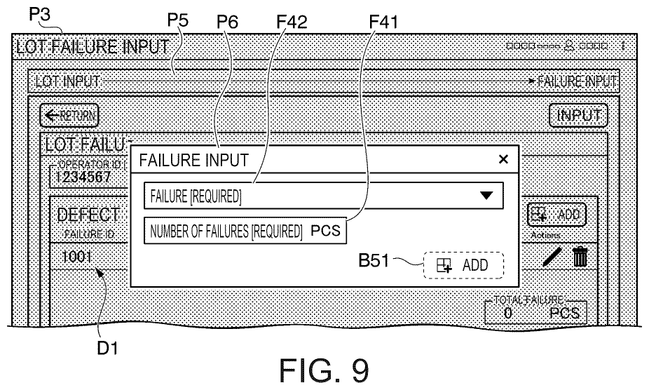

Here, for example, when the selection operation is performed at the button B51 in the nonconforming product information input image P6 shown in FIG. 8, the server 30 generates nonconforming product information including “5”, which is the nonconforming product quantity information input to the input field F41, “REASON 1: INSUFFICIENT FILLING”, which is the nonconforming reason information input to the input field F42, and nonconforming product identification information newly generated as the identification information for identifying the nonconforming product information. After generating the nonconforming product information, the server 30 adds the generated nonconforming product information to the lot information indicating the target lot. Then, as shown in FIG. 9, the server 30 causes display of the nonconforming product information added to the lot information in the nonconforming product information display region RG1 of the nonconforming product information display image P5 while maintaining the display of the nonconforming product information input image P6.

FIG. 9 is a diagram showing an example of a state in which the nonconforming product information is displayed in the nonconforming product information display region RG1 as a result of a selection operation at the button B51 shown in FIG. 8. As shown in FIG. 9, after adding the nonconforming product information to the lot information indicating the target lot as the result, the server 30 causes display of the nonconforming product information added to the lot information in the nonconforming product information display region RG1 located behind the nonconforming product information input image P6. In FIG. 9, information other than nonconforming product information identification information among the information displayed in the nonconforming product information display region RG1 is hidden behind the nonconforming product information input image P6 and is not visible. Note that in the example shown in FIG. 9, when the selection operation is performed at the button B51, the information input to each of the input field F41 and the input field F42 is deleted. This is because, after performing the selection operation at the button B51, the user may continuously input information about other nonconforming product information to the input field F41 and the input field F42. That is, the nonconforming product information input image P6 is an image capable of repeatedly receiving addition of the nonconforming product information to the lot information indicating the target lot, without accompanying the transition to another image. Therefore, the server 30 can repeatedly receive, in the nonconforming product information input image P6, nonconforming product information addition operations of adding nonconforming product information to the lot information indicating the target lot. By this, the server 30 does not need to cause the user to repeatedly perform the operation of displaying the nonconforming product information input image P6, and as a result, it is possible to improve the convenience of the user. However, if there is no need to enhance user convenience for the situation of repeatedly adding the nonconforming product information to the lot information indicating the target lot, then the server 30 may be configured such that the information that was input to each of the input field F41 and the input field F42 is not deleted, even when the selection operation is performed at the button B51.

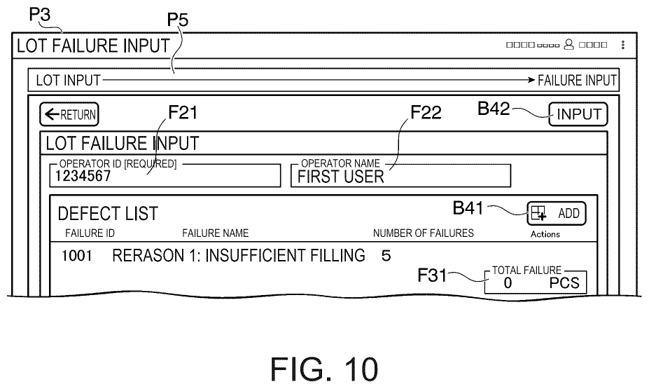

FIG. 10 is a diagram showing the nonconforming product information display image P5 indicated in FIG. 9. In FIG. 10, in order to clearly show the information displayed on the nonconforming product information display image P5, the nonconforming product information input image P6 is omitted. When the selection operation is performed at the button B51 shown in FIG. 8, the server 30 causes display of the nonconforming product information in the nonconforming product information display region RG1 as shown in FIG. 10. In the nonconforming product information display region RG1 shown in FIG. 10, the nonconforming product information is displayed, including “1001” as the nonconforming product information identification information, including “REASON 1: INSUFFICIENT FILLING” as the nonconforming reason information, and including “5” as the nonconforming product quantity information. That is, the nonconforming product information including the information input to the input field F41 and the input field F42 in FIG. 8 is displayed in the nonconforming product information display region RG1 shown in FIG. 10.

The display field F31 is a field in which is displayed the total of the number indicated by the nonconforming product quantity information included in all the nonconforming product information displayed in the nonconforming product information display region RG1. The server 30 calculates the total and causes display of the nonconforming product quantity total information in the display field F31, which indicates the calculated total, each time nonconforming product information is displayed in the nonconforming product information display region RG1. Therefore, in the display field F31 shown in FIG. 10, the total of the numbers indicated by the nonconforming product quantity information included in the nonconforming product information displayed in the nonconforming product information display region RG1 shown in FIG. 10, that is, “5”, which is the nonconforming product quantity total information indicating 5, is displayed.

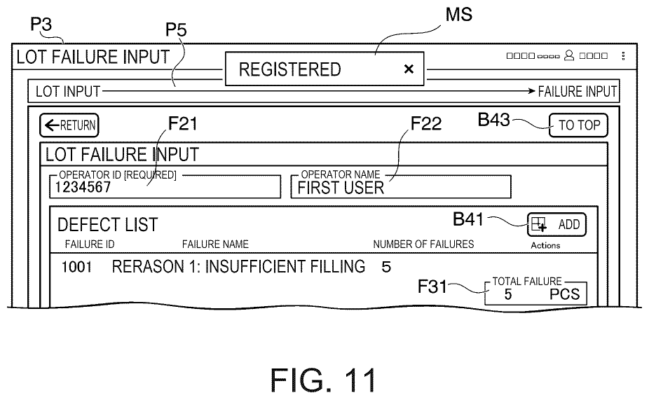

The button B42 is a button that receives an operation of completing the addition of the nonconforming product information to the lot information indicating the target lot. When a selection operation is performed at the button B42, as shown in FIG. 11, the server 30 causes display of a message MS indicating that the addition of nonconforming product information to the lot information indicating the target lot is completed. FIG. 11 is a diagram showing an example of the nonconforming product information input image P6 on which is displayed a message MS indicating that the addition of the nonconforming product information to the lot information indicating the target lot was completed. In the example shown in FIG. 11, the message MS is a character string “REGISTERED”, but it may be another character string indicating that the addition of the nonconforming product information to the lot information indicating the target lot has been completed. In this case, the server 30 changes the button B42 to the button B43.

The button B43 is a button that receives an operation of deleting the display of the nonconforming product information input image P6, deleting the display of the nonconforming product information addition image P3, and displaying the main menu image P1. When the selection operation at the button B43 is performed, the server 30 deletes the display of the nonconforming product information input image P6, deletes the display of the nonconforming product information addition image P3, and causes display of the main menu image P1. Note that in this case, the server 30 may be configured to delete the display of the nonconforming product information input image P6, delete the display of the nonconforming product information addition image P3, and may be configured to cause display of an image different from the main menu image P1.

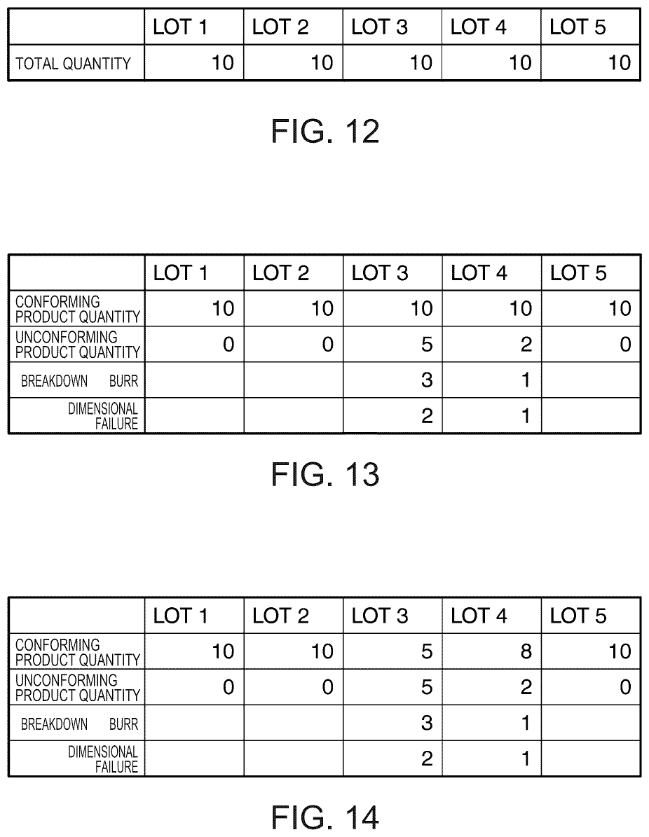

Here, with respect to the lot information of the related art, for example, a table as shown in FIG. 12 can be created. FIG. 12 is a diagram showing an example of the table indicating the number of products of each of certain five lots. However, the lot information of the related art does not include the nonconforming product information. Therefore, even if the lot information of the related art is used, it is not possible to generate a table that can confirm whether or not the nonconforming product is included in the product of the lot indicated by the lot information.

On the other hand, FIG. 13 is a diagram showing another example of the number of products in each of certain five lots. In the table shown in FIG. 13, along with the number of conforming products of each of the five lots, the number of nonconforming products of each of the five lots and the reasons why the nonconforming products of each of the five lots are nonconforming products are displayed. However, in FIG. 13, the number of conforming products of a certain lot is represented by the number of products of the lot. When the lot information generated by the server 30, that is, the lot information including the nonconforming product information is used, the user can generate the table as shown in FIG. 13. Looking at the table shown in FIG. 13, for example, the user can easily specify that nonconforming products have occurred in LOT 3 and LOT 4. This means that by adding the nonconforming product information to lot information, it is possible to easily extract lots that contain the nonconforming products. In the table shown in FIG. 13, the number of conforming products in LOT 3 is 10, while the number of nonconforming products in LOT 3 is 5. This means that 5 nonconforming products were generated in LOT 3, but the number of conforming products was adjusted to 10 because 5 conforming products were supplemented from other lots or the like. Similarly, in the table, the number of conforming products of LOT 4 is 10, while the number of nonconforming products of LOT 4 is 2. This means that 2 nonconforming products were generated in LOT 4, but the number of conforming products was adjusted to 10 because 2 conforming products were supplemented from other lots or the like. In this way, adding the nonconforming product information to the lot information via the server 30 leads to an improvement in the time series resolution of the products of the lot. Note that FIG. 14 is a diagram showing still another example of the number of products in each of certain five lots. However, also in FIG. 14, the number of conforming products of a certain lot is represented by the number of products of the lot. In the table shown in FIG. 14, the number of products of each of the five lots and the reason why the nonconforming products of each of the five lots are nonconforming products are also displayed with the number of conforming products of each of the five lots. When the lot information generated by the server 30, that is, the lot information including the nonconforming product information, is used, the user can also generate the table as shown in FIG. 14. Here, in the table shown in FIG. 14, the number of conforming products of LOT 3 is 5, while the number of nonconforming products of LOT 3 is 5. This means that 5 nonconforming products were generated in LOT 3, but the conforming products were not supplemented from other lots or the like. Similarly, in the table, the number of conforming products in LOT 4 is 8, while the number of nonconforming products of LOT 4 is 2. This means that 2 nonconforming products occurred in LOT 4, but the conforming products were not supplemented from other lots or the like. In this way, adding the nonconforming product information to the lot information via the server 30 leads to an improvement in the time series resolution of the product of the lot even when the supplementation of the conforming products to the lot is not performed.

Each product of one or more lots managed by the molding management system 1 may be configured to associate with product related information relating to the product. In this case, a certain product is associated with the product related information relating to the product. Specifically, in this case, the product related information is associated with the product by being associated with the lot identification information included in the lot information indicating the lot of the product. Therefore, the lot information indicating a certain lot includes the product related information related to each product of the lot. That is, the lot identification information included in the lot information is associated with the product related information.

The product related information associated with a certain product includes information that contains at least one of shot identification information for identifying a shot in which the product is molded and cavity identification information for identifying a cavity in which the product is molded. Therefore, the product related information may be configured to include other information relating to the product. Hereinafter, as an example, a case will be described in which the product related information includes the shot identification information and does not include the cavity identification information. Note that the shot identification information may be information for identifying a shot in the lot, may be information for identifying a shot in the injection molding device, or may be information for identifying a shot so that the user can arbitrarily reset.

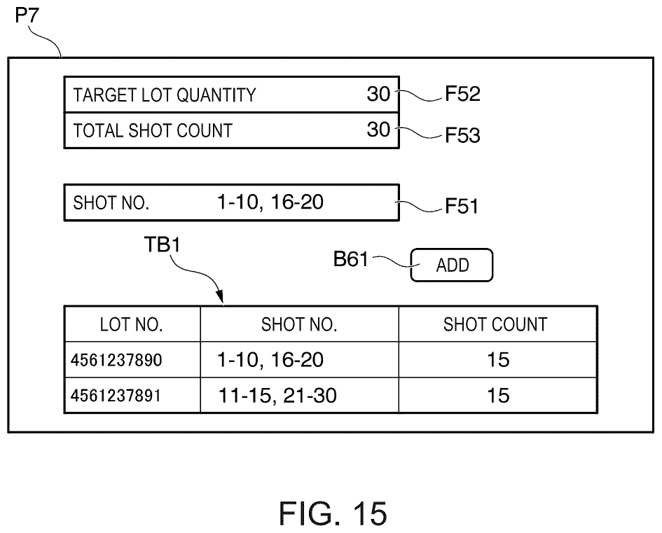

For example, when a predetermined operation is received, the server 30 causes display of a correspondence relationship reception image P7 as shown in FIG. 15. FIG. 15 is a diagram showing an example of the correspondence relationship reception image P7.

The correspondence relationship reception image P7 includes, for example, a correspondence table TB1 indicating the correspondence relationship between the lot identification information and the shot identification information, an input field F51, a button B61, a display field F52, and a display field F53. Note that the correspondence relationship reception image P7 may include another GUI instead of some or all of these, or in addition to all of these.

The correspondence table TB1 is a table showing the relationship between each of one or more sets of the lot identification information selected by the user and one or more sets of the shot identification information. Note that one or more sets of the lot identification information may be selected by any method. In the correspondence table TB1, the lot identification information is indicated by “LOT NO.”. In the correspondence table TB1, the shot identification information is indicated by “SHOT NO.”. In the correspondence table TB1, the shot number information indicating the number of the shot identification information is indicated by “NUMBER OF SHOTS”. That is, in the correspondence table TB1, the lot identification information, one or more sets of the shot identification information, and the number of one or more sets of the shot identification information are associated with each other. In the example shown in FIG. 15, for example, the lot identification information “4561237890” is associated with the shot identification information of “1-10, 16-20”. Here, “1-10, 16-20” is shot identification information indicating each of the first to tenth shots and the sixteenth to twentieth shots. The number of the shot identification information is 15. Therefore, in the present example, “15” indicating 15 is associated, as the shot number information, with “4561237890”, which is the lot identification information. In the example shown in FIG. 15, for example, the shot identification information “4561237891” is associated with the lot identification information of “11-15, 21-30”. Here, “11-15, 21-30” is shot identification information indicating the tenth to fifteenth shots and the twenty-first to thirtieth shots. The number of the shot identification information is 15. Therefore, in the present example, “15” indicating 15 is associated, as the shot count information, with “4561237891”, which is the lot identification information.

Here, in the correspondence table TB1, when no shot identification information is associated with “4561237890”, which is the lot identification information, the field displaying “1-10, 16-20” and the field displaying “15” are both blank. In this case, the GUIs used for associating the shot identification information with “4561237890”, which is the lot identification information, are the input field F51 and the button B61.

The input field F51 is a field in which is input the shot identification information. In the input field F51, one or more sets of the shot identification information may be input separated by commas, a range of the shot identification information may be input, or the shot identification information may be input by a combination thereof as shown in FIG. 15. The input of the shot identification information to the input field F51 may be performed by selecting the shot identification information from a pull-down menu or may be performed by direct input using the input device such as the keyboard.

The button B61 is a button for confirming that the shot identification information input to the input field F51 is associated with the lot identification information selected by the user in the correspondence table TB1. When a selection operation is performed at the button B61 in a state where shot identification information is input to the input field F51, the server 30 causes display of the shot identification information input to the input field F51 in a field adjacent to the right of the lot identification information in the correspondence table TB1 and associates the shot identification information with the lot identification information. The server 30 causes display of the shot number information indicating the number of the shot identification information input to the input field F51 in a field to the right of the shot identification information in the correspondence table TB1.

In this way, the user can associate the lot identification information with the shot identification information by using the input field F51 and the button B61. Note that the display field F52 is a field in which is displayed the total number of the products of the lot identified by each set of lot identification information displayed in the correspondence table TB1. In the example shown in FIG. 15, “30” indicating 30 is displayed in the display field F52. The display field F53 is a field in which is displayed the total number of the shot identification information associated with each lot identification information displayed in the correspondence table TB1. In the example shown in FIG. 15, “30” indicating 30 is displayed in the display field F53.

Here, when shot identification information is associated with certain lot identification information, the server 30 treats the shot identification information as one piece of information included in the lot information indicating a lot identified by the lot identification information. In this case, instead of associating the nonconforming product information with the lot identification information included in the lot information indicating a certain lot, the server 30 may be configured to associate the nonconforming product information with each shot identification information included in the lot information. In this case, for example, the nonconforming product information input image P6 includes an input field in which the shot identification information desired by the user is input. In this case, the shot identification information input to the input field is also displayed in the nonconforming product information display region RG1. This enables the server 30 to easily identify which shots are more likely to result in nonconforming products. As a result, the server 30 can track how the nonconforming products flow in each lot. That is, the server 30 can improve the traceability of nonconforming products. Further, in the production of the product by a production device in which, for example, the injection molding device and an image inspection device are combined, the server 30 can realize boxing or the like, which is performed by a transport device such as a robot, that distinguishes between the conforming products and the nonconforming products. The server 30 can easily specify to the user whether or not nonconforming product has occurred in any process of each process performed on the product of the lot.

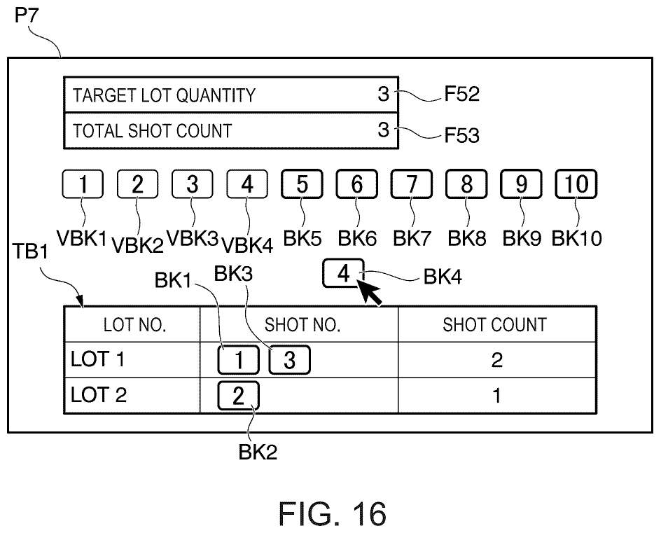

Note that the method of inputting the shot identification information to the field to the right of the lot identification information in the correspondence table TB1 may be another method. FIG. 16 is a diagram for explaining another example of an input method of the shot identification information to the right adjacent field of the lot identification information in the correspondence table TB1 shown in FIG. 15. Hereinafter, for convenience of description, the above input field will be referred to as a shot identification information input field.

In the example shown in FIG. 16, the shot identification information different from each other is shown above the correspondence table TB1, and a plurality of images that can be dragged and dropped are displayed. Each of the image BK1 to the image BK10 shown in FIG. 16 shows an example of the plurality of images. Specifically, when n is any integer from 1 to 10, an image BKn indicates the shot identification information for identifying the n-th shot. In the example shown in FIG. 16, the image BK1 and the image BK3 are input to the upper shot identification information input field of the two shot identification information input fields by a drag-and-drop. This means that the shot identification information that identifies each of the first shot and the third shot has been input to the shot identification information input field. In the present example, a state where the image BK4 is dragging to the shot identification information input field is shown. In the present example, the image BK2 is input to the lower shot identification information input field of the two shot identification information input fields by the drag-and-drop. This means that the shot identification information that identifies the second shot has been input to the shot identification information input field. Here, when the image BKn is dragged, the server 30 causes display of an image indicating that the image BKn was positioned at the position where the image BKn was positioned before being dragged. An image VBKn is an example of an image indicating that the image BKn was positioned. Specifically, for example, the image VBK1 is an image indicating that the image BK1 was positioned. By this, the user can return the erroneously input image BKn to its original position in a certain shot identification information input field by drag-and-drop and can easily cancel the input to the shot identification information input field. Note that, the movement of the image BKn to the shot identification information input field may be performed by another method, such as one involving a GUI that receives an operation to instruct the server 30 to execute the movement, instead of using drag-and-drop.

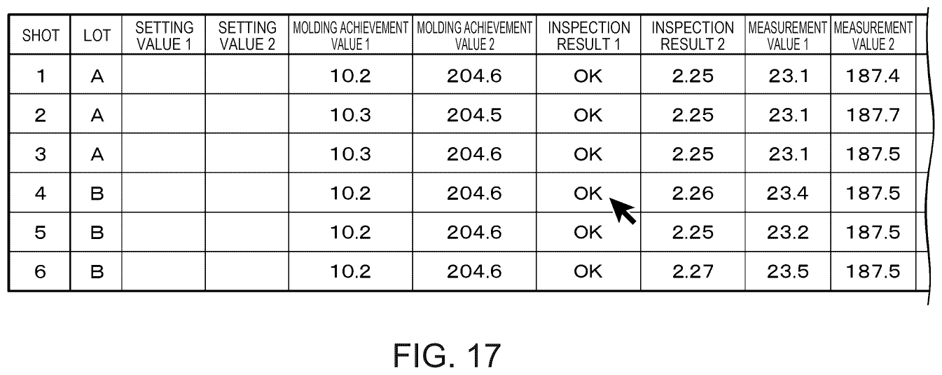

Here, FIG. 17 is a table showing an example of a case where a list of the lot information is displayed using the shot identification information as a primary key. Note that, in FIG. 17, a part of each lot information is omitted to eliminate complexity in the case of drawing all of the lot information. In the example shown in FIG. 17, the shot identification information is indicated by “SHOT”. In the present example, the lot identification information is indicated by “LOT”. Each of “SETTING VALUE 1” and “SETTING VALUE 2” in the table shown in FIG. 17 indicates information representing a parameter set in the injection molding device for molding the product. Each of the “SETTING VALUE 1” and the “SETTING VALUE 2” is, for example, a measured value, a velocity pressure (VP) switching position, or the like, but is not limited to these. Each of “MOLDING ACHIEVEMENT VALUE 1” and “MOLDING ACHIEVEMENT VALUE 2” in the present table indicates information representing various achievement values by the injection molding device for molding the product. Each of the “MOLDING ACHIEVEMENT VALUE 1” and the “MOLDING ACHIEVEMENT VALUE 2” is, for example, an injection most forward position, a maximum injection pressure, a cycle time, and the like, but is not limited to these. Each of “INSPECTION RESULT 1” and “INSPECTION RESULT 2” in the present table indicates information representing inspection results of the product. Each of the “INSPECTION RESULT 1” and the “INSPECTION RESULT 2” is, for example, an image inspection result, a manual measurement result, artificial intelligence (AI), or the like, but is not limited to these. Each of the “INSPECTION RESULT 1” and the “INSPECTION RESULT 2” may be information indicating a result of binary determination of OK or NG (Not Good), or may be information indicating a numerical value. Each of “MEASUREMENT VALUE 1” and “MEASUREMENT VALUE 2” in the present table represents information indicating a value detected by various sensors attached to the injection molding device or the like. Each of the “MEASUREMENT VALUE 1” and the “MEASUREMENT VALUE 2” is, for example, information indicating a value detected by the sensor attached to the injection molding device, information indicating a value detected by the sensor attached to the metal mold, and the like, but is not limited to these.

When the configuration of the lot information is as shown in FIG. 17, the user can manage the lot on a shot-by-shot basis. In the example shown in FIG. 17, the shot identification information that identifies each of the first to the third shots is associated with “A”, which is the lot identification information that identifies lot A. That is, in the present example, the shot identification information that identifies each of the first to the third shots is included in the lot information indicating the lot A. On the other hand, in the present example, the shot identification information that identifies each of the fourth to the sixth shots is associated with “B”, which is the lot identification information that identifies lot B. That is, in the present example, the shot identification information that identifies each of the fourth to the sixth shots is included in the lot information indicating the Lot B. These lot information include the nonconforming product information omitted in FIG. 17. By this, the server 30 can suppress the occurrence of a difference between the actual lot in which the nonconforming product is generated and the lot in the molding management system. Further, the server 30 can improve the traceability of each of the conforming products and the nonconforming products of the lot. The server 30 can add other information to the lot information that is capable of further improving the traceability by including the nonconforming product information in the lot information.

As described above, the server 30 capable of causing display of images such as the nonconforming product information addition image P3 on the terminal device 40 is, for example, a workstation, a desktop Personal Computer (PC), a notebook PC, or the like, but is not limited to these. The server 30 may be configured to be integral with the information process device 20.

The server 30 is communicatively connected to the information process device 20 by communication via a wire or wireless. The communication network connecting the server 30 and information process device 20 may be, for example, the LAN in the facility where the plurality of managed devices 10 is installed, may be the Internet, may be a mobile communication network, or may be another communication network. Hereinafter, as an example, a case where the communication network connecting the server 30 and the information process device 20 is the Internet will be described. In this case, the server 30 is a cloud server.

The server 30 is communicatively connected to the terminal device 40 via communication via a wire or wireless. In the example shown in FIG. 1, the server 30 is communicably connected to the terminal device 40 by wireless communication. The communication network connecting the server 30 and the terminal device 40 may be, for example, the LAN in the facility where the server 30 is installed, may be the Internet, may be the mobile communication network, or may be another communication network. Hereinafter, as an example, a case where the communication network connecting the server 30 and the terminal device 40 is the Internet will be described.

### Hardware Configuration of Server

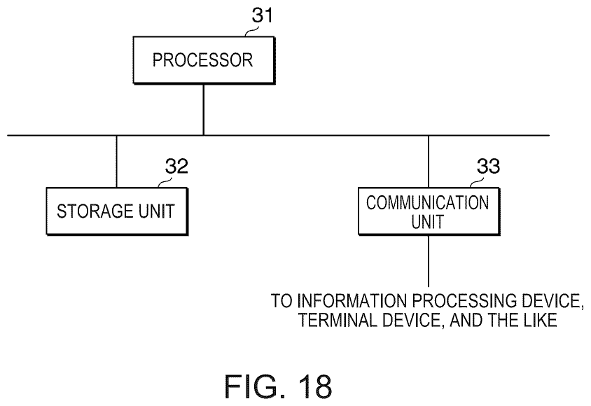

Hereinafter, the hardware configuration of the server 30 will be described with reference to FIG. 18. FIG. 18 is a diagram showing an example of the hardware configuration of the server 30.

The server 30 includes, for example, a processor 31, a storage section 32, and a communication section 33. These components are communicably connected to each other via a bus. The server 30 communicates with both each of the information process device 20 and the terminal device 40 via the communication section 33.

The processor 31 is, for example, a Central Processing Unit (CPU). Note that the processor 31 may be another processor such as a Field Programmable Gate Array (FPGA) instead of the CPU. The processor 31 executes various programs stored in the storage section 32.

The storage section 32 is a storage device including, for example, a Hard Disk Drive (HDD), a Solid State Drive (SSD), an Electrically Erasable Programmable Read Only Memory (EEPROM), a Read Only Memory (ROM), and a Random Access Memory (RAM). Note that the storage section 32 instead of being built into the server 30, may be an external storage device connected by a digital input-output port such as Universal Serial Bus (USB). The storage section 32 stores various information, various images, and various programs processed by the server 30. That is, various kinds of information stored in the server 30 are stored in storage section 32.

The communication section 33 is a communication device configured to include, for example, the digital input/output port such as the USB, an Ethernet (R) port, and an antenna for wireless communication.

### Functional Configuration of Server

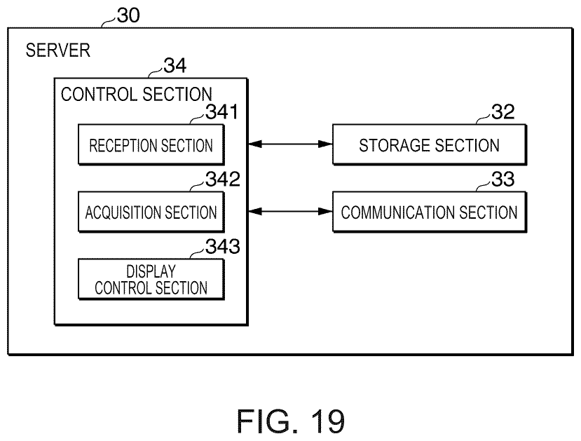

Hereinafter, a functional configuration of the server 30 will be described with reference to FIG. 19. FIG. 19 is a diagram showing an example of the functional configuration of the server 30.

The server 30 includes the storage section 32, the communication section 33, and a control section 34.

The control section 34 controls the entire server 30. The control section 34 includes a reception section 341, an acquisition section 342, and a display control section 343. These functional units included in the control section 34 are realized, for example, by the processor 31 executing various programs stored in the storage section 32. Some or all of the functional sections may be hardware functional sections such as a Large Scale Integration (LSI) and an Application Specific Integrated Circuit (ASIC).

The reception section 341 receives various kinds of information and various kinds of operations from a device communicably connected to the server 30.

The acquisition section 342 acquires, for each of the plurality of managed devices 10, the state information for the managed device 10 from the managed device 10 via the information process device 20. The acquisition section 342 may be configured to acquire the state information directly from the managed device 10 without using the information process device 20.

The display control section 343 generates various types of images according to operations received via the reception section 341. The display control section 343 transmits the generated image to the terminal device 40 and causes the terminal device 40 to display the image.

### Process in Which the Server Adds the Nonconforming Product Information to the Lot Information

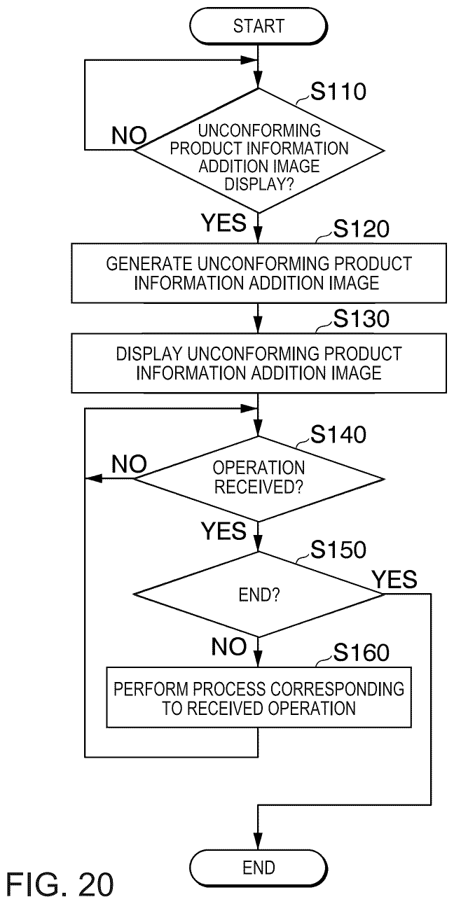

A process in which the server 30 adds the nonconforming product information to the lot information will be described with reference to FIG. 20. FIG. 20 is a diagram showing an example of a flow of process in which the server 30 adds the nonconforming product information to the lot information. Hereinafter, as an example, a case will be described in which the terminal image P2 is displayed on the terminal device 40 at a timing before the process of step S110 shown in FIG. 20 is performed. Hereinafter, as an example, a case will be described in which each of the master data and the lot information is already stored in the server 30 at the timing.

The control section 34 waits until a selection operation at the button B21 is received, that is, an operation for displaying the nonconforming product information addition image P3 via the terminal device 40 (step S110). In FIG. 20, the process of step S110 is indicated by “UNCONFORMING PRODUCT INFORMATION ADDITION IMAGE DISPLAY?”.

When the control section 34 determines that the operation for displaying the nonconforming product information addition image P3 was received via the terminal device 40 (YES in step S110), it generates the nonconforming product information addition image P3 (step S120). The method of generating the nonconforming product information addition image P3 in step S120 may be a known method or a method to be developed.

Next, the control section 34 transmits the nonconforming product information addition image P3 generated in step S120 to the terminal device 40 and causes the terminal device 40 to display the nonconforming product information addition image P3 (step S130).

Next, the control section 34 waits until an operation is received via the nonconforming product information addition image P3 displayed on the terminal device 40 (step S140). In FIG. 20, the process of step S140 is indicated by “OPERATION RECEIVED?”.

When the control section 34 determines that the operation was received via the nonconforming product information addition image P3 displayed on the terminal device 40 (YES in step S140), it determines whether or not the received operation is an operation for ending the processing of the flowchart shown in FIG. 20 (step S150). The determination process of step S150 by the control section 34 may be performed by a known method or a method to be developed. In FIG. 20, the process of step S150 is indicated by “END?”.

When the control section 34 determines that the operation received at step S140 is the operation for ending the process of the flowchart shown in FIG. 20 (YES in step S150), it deletes, for example, the display of the nonconforming product information addition image P3 from the terminal device 40, and ends the process of the flowchart shown in FIG. 20.

On the other hand, when the control section 34 determines that the operation received in step S140 is not the operation for ending the process of the flowchart shown in FIG. 20 (NO in step S150), it performs a process corresponding to the received operation (step S160). Here, since the process performed by the control section 34 in step S160 has already been described in the description of FIG. 4 to FIG. 11, a detailed description will be omitted.

After the process of step S160 is performed, the control section 34 proceeds to step S140 and waits again until an operation is received via the nonconforming product information addition image P3 displayed on the terminal device 40.

By the processing as described above, the server 30 causes display of the nonconforming product information addition image P3 for receiving the nonconforming product information addition operation for adding the nonconforming product information including the nonconforming product quantity information indicating the number of nonconforming products to the lot information indicating the selected target lot among the lots indicated by one or more sets of the lot information stored in storage section 32. By this, the server 30 can suppress the occurrence of a difference between the actual lot in which the nonconforming product is generated and the lot in the molding management system 1.

Note that the molding management system 1 described above may be configured to include the terminal device 40.

The above described search for the lot may be performed using a time period in which the lot was not operating normally as the search key. In this case, the lot related information includes information indicating the time period.

The above described search for the lot may be performed using one or more sets of information included in the injection molding device related information as the search key. In this case, the lot related information includes the injection molding device related information. The injection molding device related information included in the lot related information related to a certain lot is information related to the injection molding device that molds the products of the lot, and as described above, for example, is information including the operating state information indicating an operating state of the injection molding device, the detection information regarding the injection molding device, and the like. By this, the server 30 can more reliably improve the traceability of the product.

The above described search for the lot may be performed using any arbitrary string as the search key. In this case, when the server 30 receives an arbitrary character string, it specifies information including the received character string from one or more sets of information included in the lot related information and it causes display of a list of the lot information indicating the lot identified by each set of the lot identification information associated with the specified information. By this, the server 30 can make it easier for the user to search for the lot.

The contents described above may be combined in any manner.

### Appendices

[1] A molding management system that manages production of a product in a production process including an injection molding process of the product by an injection molding device, the molding management system includes a server communicably connected to a terminal device, wherein the server includes a storage section configured to store one or more sets of lot information in which lot identification information for identifying a lot of the product and lot related information including one or more sets of information relating to the lot of the product are associated with each other and a control section configured to cause the terminal device to display a nonconforming product information addition image for receiving a nonconforming product information addition operation for adding, to the lot information that indicates a target lot that was selected from the lots indicated by each of one or more sets of the lot information stored in the storage section, nonconforming product information including nonconforming product quantity information indicating the number of nonconforming products.

[2] The molding management system according to [1], wherein the nonconforming product information addition image includes a nonconforming product quantity information input image for receiving an operation of inputting the nonconforming product quantity information and the control section receives, in the nonconforming product information addition image, the nonconforming product information addition operation of adding the nonconforming product information including the nonconforming product quantity information that was input via the nonconforming product quantity information input image to the lot information indicating the target lot.

[3] The molding management system, wherein according to [2], wherein the nonconforming product information addition image includes a nonconforming reason information input image for receiving an operation of inputting nonconforming reason information indicating a reason why the products, in the number indicated in the nonconforming product quantity information that was input via the nonconforming product quantity information input image, are nonconforming products and the control section receives, in the nonconforming product information addition image, the nonconforming product information addition operation of adding, to the lot information indicating the target lot, the nonconforming product information including the nonconforming product quantity information that was input via the nonconforming product quantity information input image and the nonconforming reason information that was input via the nonconforming reason information input image.

[4] The molding management system, wherein according to [3], wherein the nonconforming product information addition image is an image for receiving an operation of selecting desired nonconforming reason information from among one or more sets of nonconforming reason information, the storage section is configured to store master data, and the one or more sets of the nonconforming reason information are included in the master data stored in the storage section.

[5] The molding management system, according to any one of [1] to [4], wherein the nonconforming product information addition image is an image configured to, without transitioning to another image, repeatedly receive the addition of nonconforming product information to the lot information indicating the target lot and the control section is configured to repeatedly receive, in the nonconforming product information addition image, the nonconforming product information addition operation of adding the nonconforming product information to the lot information indicating the target lot.

[6] The control section causes the terminal device to display a correspondence relationship reception image for associating the target lot with shot identification information for identifying a shot in which the product is molded.

[7] The molding management system according to any one of [1] to [6], wherein the lot related information includes, as the one or more sets of information, injection molding device related information related to the injection molding device that molds the product of the lot identified by the lot identification information associated with the lot related information and the injection molding device related information includes at least one of operating state information indicating an operating state of the injection molding device or detection information detected by each of one or more of sensors attached to the injection molding device.

Note that the injection molding device described in [7] may be the same injection molding device as the one described in [1], or it may be a different injection molding device from the one described in [1]. Therefore, the article used for injection molding device in [7] is “a” and not “the”.

[8] The molding management system according to any one of [1] to [7], wherein the lot related information includes quality information of the product of the lot identified by the lot identification information associated with the lot related information.

[9] The molding management system according to any one of [1] to [8], wherein the lot related information includes process information indicating the work process currently being performed on the product of the lot identified by the lot identification information associated with the lot related information.

The molding management system according to any one of [1] to [9], further includes the terminal device.

The molding management system according to any one of [1] to [10], further includes the injection molding device.

Although the embodiments of the present disclosure have been described in detail with reference to the drawings, specific configurations are not limited to the embodiments, and changes, substitutions, deletions, and the like may be made without departing from the gist of the present disclosure.

A program for realizing a function of an arbitrary configuration section in the device described above may be recorded in a computer-readable recording medium, and the program may be read and executed by a computer system. Here, the device is, for example, the injection molding device 11, the information process device 20, the server 30, the terminal device 40, or the like. Note that the term “computer system” as used herein includes an Operating System (OS) and hardware such as peripheral devices. The “computer-readable recording medium” refers to a portable medium such as a flexible disk, a magneto-optical disk, a ROM, or a Compact Disk (CD)-ROM, or a storage device such as a hard disk built in the computer system. Further, “computer-readable recording medium” includes a medium that holds a program for a certain period of time, such as a volatile memory inside a computer system serving as a server or a client when the program is transmitted via a network such as the Internet or a communication line such as a telephone line.

The program may be transmitted from the computer system in which the program is stored in the storage device or the like to another computer system via a transmission medium or by a transmission wave in the transmission medium. Here, “transmission medium” for transmitting the program refers to a medium having a function of transmitting information such as a network such as the Internet or a communication line such as a telephone line.

The above described program may be a program for realizing a part of the above described functions. Further, the above described program may be a so-called difference file or difference program that can realize the above described functions in combination with a program already recorded in the computer system.

What is claimed is:

1. A molding management system that manages production of a product in a production process including an injection molding process of the product by an injection molding device, the molding management system comprising;
a server communicably connected to a terminal device, wherein
the server includes
a storage section configured to store one or more sets of lot information in which lot identification information for identifying a lot of the product and lot related information including one or more sets of information relating to the lot of the product are associated with each other and
a control section configured to cause the terminal device to display a nonconforming product information addition image for receiving a nonconforming product information addition operation for adding, to the lot information that indicates a target lot that was selected from the lots indicated by each of one or more sets of the lot information stored in the storage section, nonconforming product information including nonconforming product quantity information indicating the number of nonconforming products.

2. The molding management system according to claim 1, wherein
the nonconforming product information addition image includes a nonconforming product quantity information input image for receiving an operation of inputting the nonconforming product quantity information and
the control section receives, in the nonconforming product information addition image, the nonconforming product information addition operation of adding the nonconforming product information including the nonconforming product quantity information that was input via the nonconforming product quantity information input image to the lot information indicating the target lot.

3. The molding management system according to claim 2, wherein
the nonconforming product information addition image includes a nonconforming reason information input image for receiving an operation of inputting nonconforming reason information indicating a reason why the products, in the number indicated in the nonconforming product quantity information that was input via the nonconforming product quantity information input image, are nonconforming products and
the control section receives, in the nonconforming product information addition image, the nonconforming product information addition operation of adding, to the lot information indicating the target lot, the nonconforming product information including the nonconforming product quantity information that was input via the nonconforming product quantity information input image and the nonconforming reason information that was input via the nonconforming reason information input image.

4. The molding management system according to claim 3, wherein
the nonconforming product information addition image is an image for receiving an operation of selecting desired nonconforming reason information from among one or more sets of nonconforming reason information,
the storage section is configured to store master data, and
the one or more sets of the nonconforming reason information are included in the master data stored in the storage section.

5. The molding management system according to claim 1, wherein
the nonconforming product information addition image is an image configured to, without transitioning to another image, repeatedly receive the addition of nonconforming product information to the lot information indicating the target lot and
the control section is configured to repeatedly receive, in the nonconforming product information addition image, the nonconforming product information addition operation of adding the nonconforming product information to the lot information indicating the target lot.

6. The molding management system according to claim 1, wherein
the control section causes the terminal device to display a correspondence relationship reception image for associating the target lot with shot identification information for identifying a shot in which the product is molded.

7. The molding management system according to claim 1, wherein
the lot related information includes, as the one or more sets of information, injection molding device related information related to the injection molding device that molds the product of the lot identified by the lot identification information associated with the lot related information and
the injection molding device related information includes at least one of operating state information indicating an operating state of the injection molding device or detection information detected by each of one or more of sensors attached to the injection molding device.

8. The molding management system according to claim 1, wherein
the lot related information includes quality information of the product of the lot identified by the lot identification information associated with the lot related information.

9. The molding management system according to claim 1, wherein
the lot related information includes process information indicating the work process currently being performed on the product of the lot identified by the lot identification information associated with the lot related information.

10. The molding management system according to claim 1, further comprising;
the terminal device.

11. The molding management system according to claim 1, further comprising;
the injection molding device.
